(19) United States
(12) Patent Application Publication
(10) Pub. No.: US 2014/0361090 A1
(43) Pub. Date: Dec. 11, 2014

(54) RFID TAG AND RFID TAG MANUFACTURING METHOD

(71) Applicant: FUJITSU LIMITED, Kawasaki-shi (JP)

(72) Inventor: Shunji Baba, Yokohama (JP)

(21) Appl. No.: 14/469,639

(22) Filed: Aug. 27, 2014

Related U.S. Application Data
(63) Continuation of application No. PCT/JP2012/058736, filed on Mar. 30, 2012.

(51) Int. Cl. G06K 19/077

(52) U.S. Cl. CPC G06K 19/0779; G06K 19/07777; G06K 19/07745
USPC 235/492; 29/601

(57) ABSTRACT

An RFID tag that includes a spacer made of a first member having flexibility and elasticity, the spacer having a top surface, a lateral surface and a bottom surface, an antenna made of a conductive material having flexibility and elasticity and disposed on the top surface, the lateral surface and the bottom surface of the spacer, and an IC chip electrically connected to the antenna.

### CROSS-REFERENCE TO RELATED APPLICATION

This application is a continuation application of International Application PCT/JP2012/058736 filed on Mar. 30, 2012 and designated the U.S., the entire contents of which are incorporated herein by reference.

### FIELD

The embodiment discussed herein is related to an RFID (Radio Frequency Identification) tag and an RFID tag manufacturing method.

### BACKGROUND

There has been an RFID tag which includes a cuboid dielectric member having a designated dielectric constant, transceiving antenna patterns formed on surfaces of the dielectric member in a loop shape by etching or the like, and an IC chip which is electrically connected to the antenna patterns via a chip-mounted pad. If the RFID tag is attached to a radio wave absorber such as a bottle containing a liquid or a human body, the antenna patterns form a tiny loop antenna. As a result, a current loop is formed in the radio wave absorber as well (for example, see Patent Document 1).

The conventional RFID tag includes the cuboid dielectric member as a spacer in order to heighten the antenna patterns in three dimensions so that communication performance of the antenna patterns is not affected in a case where the RFID tag is attached to a metal surface of a product or a container which can contain an object that reflects or absorbs electromagnetic waves.

Since the conventional RFID tag does not have a structure suitable for bending, the RFID tag cannot be bent freely. Accordingly, it is difficult to attach the RFID tag on various curved surfaces.

### RELATED-ART DOCUMENTS

### Patent Documents

[Patent Document 1] Japanese Laid-open Patent Publication No. 2006-053833

### SUMMARY

According to an aspect of the present application, there is provided an RFID tag including a spacer made of a first member having flexibility and elasticity, the spacer having a top surface, a lateral surface and a bottom surface, an antenna made of a conductive material having flexibility and elasticity and disposed on the top surface, the lateral surface and the bottom surface of the spacer, and an IC chip electrically connected to the antenna.

The object and advantages of the disclosure will be realized and attained by means of the elements and combinations particularly pointed out in the claims.

It is to be understood that both the foregoing general description and the following detailed description are exemplary and explanatory and are not restrictive of the invention as claimed.

### BRIEF DESCRIPTION OF DRAWINGS

FIG. 1A is a diagram illustrating a cross-sectional view of an RFID tag according to a first comparative example;

FIG. 1B is a diagram illustrating a cross-sectional view of the RFID tag according to a first comparative example in a state where the RFID tag is bent;

FIG. 2A is a diagram illustrating a cross-sectional view of an RFID tag according to a second comparative example;

FIG. 2B is a diagram illustrating a cross-sectional view of the RFID tag according to the second comparative example in a state where the RFID tag 20 is bent;

FIG. 3 is a diagram illustrating states where a thin RFID tag is attached to curved surfaces;

FIG. 4A is a diagram illustrating an RFID tag according to a first embodiment in side view;

FIG. 4B is a diagram illustrating the RFID tag according to the first embodiment in plan view;

FIG. 4C is a diagram illustrating a cross section of the RFID tag according to the first embodiment taken along A-A line illustrated in FIG. 4B;

FIG. 5A is a diagram illustrating an antenna of the RFID tag according to the first embodiment in plan view;

FIG. 5B is a diagram illustrating a cross section taken along B-B line as illustrated in FIG. 5A;

FIG. 5C is a diagram illustrating an antenna and an IC chip of the RFID tag according to the first embodiment in plan view;

FIG. 5D is a diagram illustrating a cross section taken along C-C line as illustrated in FIG. 5C;

FIG. 6A is a diagram illustrating a configuration of a silver paste used for forming the antenna of the RFID tag according to the first embodiment;

FIG. 6B is a diagram illustrating the silver paste in a state of being pulled sideways;

FIG. 7A is a diagram illustrating a cross section of the RFID tag according to the first embodiment in a normal state;

FIG. 7B is a diagram illustrating a cross section of the RFID tag according to the first embodiment bent along a longitudinal direction;

FIG. 8A is a diagram illustrating manufacturing processes of the RFID tag according to the first embodiment;

FIG. 8B is a diagram illustrating manufacturing processes of the RFID tag according to the first embodiment;

FIG. 8C is a diagram illustrating manufacturing processes of the RFID tag according to the first embodiment;

FIG. 9A is a diagram illustrating manufacturing processes of the RFID tag according to the first embodiment;

FIG. 9B is a diagram illustrating manufacturing processes of the RFID tag according to the first embodiment;

FIG. 9C is a diagram illustrating manufacturing processes of the RFID tag according to the first embodiment;

FIG. 9D is a diagram illustrating manufacturing processes of the RFID tag according to the first embodiment;

FIG. 10A is a diagram illustrating manufacturing processes of the RFID tag according to the first embodiment;

FIG. 10B is a diagram illustrating manufacturing processes of the RFID tag according to the first embodiment;

FIG. 10C is a diagram illustrating manufacturing processes of the RFID tag according to the first embodiment;

FIG. 10D is a diagram illustrating manufacturing processes of the RFID tag according to the first embodiment;

FIG. 11A is a diagram illustrating an RFID tag according to a second embodiment in plan view;

FIG. 11B is a diagram illustrating the RFID tag according to the second embodiment in side view;

FIG. 11C is a diagram illustrating a cross section of the RFID tag according to the second embodiment taken along D-D line illustrated in FIG. 11A;

FIG. 12 is a diagram illustrating a cross section of the RFID tag according to the second embodiment bent along a longitudinal direction;

FIG. 13A is a diagram illustrating a manufacturing process of the RFID tag according to the second embodiment;

FIG. 13B is a diagram illustrating a manufacturing process of the RFID tag according to the second embodiment;

FIG. 14A is a diagram illustrating a manufacturing process of the RFID tag according to the second embodiment;

FIG. 14B is a diagram illustrating a manufacturing process of the RFID tag according to the second embodiment;

FIG. 15A is a diagram illustrating a manufacturing process of the RFID tag according to the second embodiment;

FIG. 15B is a diagram illustrating a manufacturing process of the RFID tag according to the second embodiment;

FIG. 16A is a diagram illustrating an RFID tag according to a third embodiment in perspective view;

FIG. 16B is a diagram illustrating a module 300 included in the RFID tag according to the third embodiment in three-surface folded out view;

FIG. 16C is a diagram illustrating a manufacturing process of RFID tag according to the third embodiment;

FIG. 17 is a diagram illustrating an RFID tag according to a fourth embodiment in cross-sectional view;

FIG. 18A is a diagram illustrating a strap of the RFID tag according to the fourth embodiment; and

FIG. 18B is a diagram illustrating the strap of the RFID tag according to the fourth embodiment.

### DESCRIPTION OF EMBODIMENT

Hereinafter, an embodiment to which an RFID tag and an RFID tag manufacturing method of the present invention are applied will be described.

Before illustrating the RFID tag and RFID tag manufacturing method of the embodiments, problems of RFID tags according to first and second comparative examples are described.

### FIRST COMPARATIVE EXAMPLE

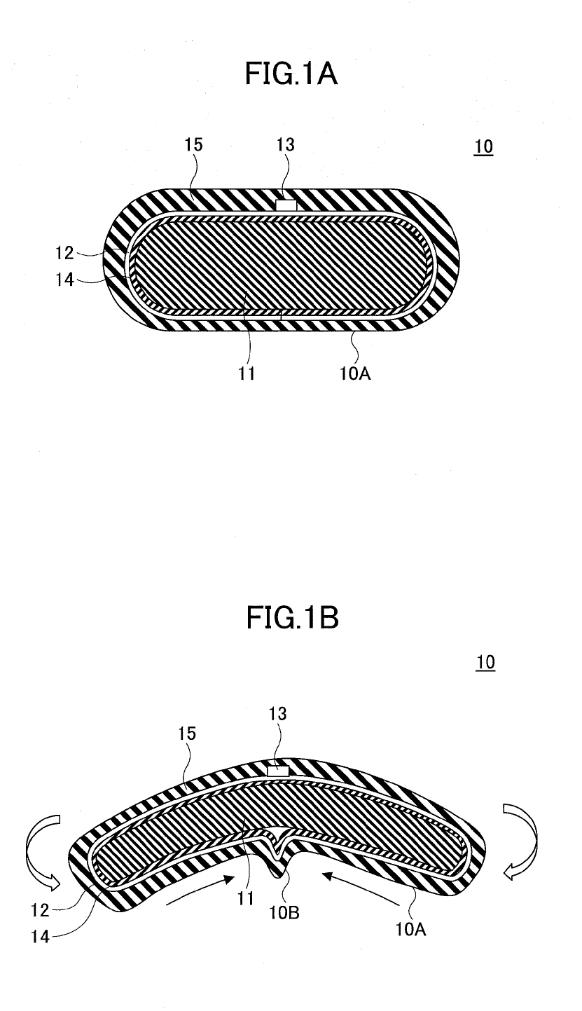

FIG. 1A is a diagram illustrating a cross-sectional view of an RFID tag 10 according to the first comparative example.

The RFID tag 10 includes a spacer 11, an antenna 12, an IC chip 13, a polyethylene terephthalate (PET) film 14 and a cover 15. The RFID tag 10 is attached to a product by attaching a bottom surface 10A to the product with a double-faced adhesive tape or the like.

The antenna 12 and the IC chip 13 are mounted on a surface of the PET film 14.

The spacer 11 is made of rubber. The PET film 14 is adhered to the spacer 11. Accordingly, the antenna 12 is formed in a loop shape. The spacer is provided for the sake of forming the loop of the antenna 12 in a three-dimensional shape with respect to a surface of the product.

The antenna 12 is formed on a surface of the PET film 14. The antenna 12 is formed in an intended pattern on the surface of the PET film 14 by printing a silver paste or by etching an aluminum foil or a copper foil formed on the surface of the PET film 14, for example.

The IC chip 13 is mounted on the surface of the PET film 14 and is electrically connected to the antenna 12. The IC chip 13 includes a memory chip and stores data representing a unique identification (ID) in the memory chip. When the IC chip 13 receives a read signal in a radio frequency (RF) band from a reader/writer of the RFID tag 10 via the antenna 12, the IC chip 13 is activated by power of the read signal and transmits the data representing the ID via the antenna 12. Accordingly, the reader/writer can read the ID of the RFID tag 10.

The antenna 12 is formed on the surface of the PET film 14 and the IC chip 13 is mounted on the surface. The PET film 14 is adhered to a top surface, a bottom surface and both lateral surfaces of the spacer 11 in a state where the antenna 12 is formed on the surface of the PET film 14 and the IC chip 13 is mounted on the surface. By connecting both ends of the antenna 12, the antenna 12 becomes a loop antenna.

The cover 15 covers entire surfaces of the spacer 11, the antenna 12, the IC chip 13 and the PET film 14. The cover 15 is made of rubber.

The RFID tag 10 heightens the antenna 12 by giving the three-dimensional shape as described above so that the RFID tag 10 can perform communications through the antenna 12 in a case where the RFID tag 10 is attached to a metal product, a container which can contain an object that reflects or absorbs electromagnetic waves or the like.

FIG. 1B is a diagram illustrating a cross-sectional view of the RFID tag 10 in a state where the RFID tag 10 is bent.

In FIG. 1B, the RFID tag 10 is bent so that the bottom surface 10A is made concave, i.e. the bottom surface 10A is curved upward toward the middle. A situation as described above corresponds to a case where the RFID tag 10 is attached to a lateral surface of a bottle having a cylindrical shape, for example.

Since the PET film 14 does not shrink, a convex portion 10B appears in the middle of the bottom surface 10A in a case where the RFID tag 10 is attached to a curved surface. Since the PET film 14 is forced downward, the convex portion 10B appears.

If the convex portion 10B appears, it becomes difficult to attach the RFID tag 10 on the curved surface.

In the following, an RFID tag according to a second comparative example is described.

### SECOND COMPARATIVE EXAMPLE

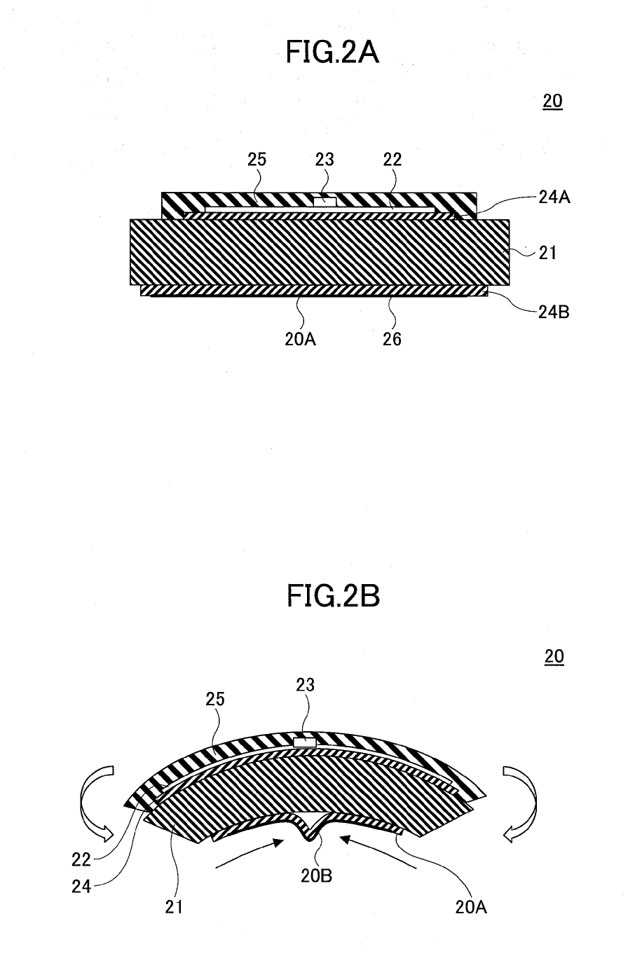

FIG. 2A is a diagram illustrating a cross-sectional view of an RFID tag 20 according to the second comparative example.

The RFID tag 20 includes a spacer 21, an antenna 22, an IC chip 23, polyethylene terephthalate (PET) films 24A and 24B, a cover 25 and an electromagnetic wave reflector 26. The RFID tag 20 is attached to a product by attaching a bottom surface 20A to the product with a double-faced adhesive tape or the like.

The spacer 21 is made of rubber. The spacer 21 is provided for the sake of heightening the antenna 22 with respect to a surface of the product.

The antenna 22 is formed on a surface of the PET film 24A. The antenna 22 is formed in an intended pattern on the surface of the PET film 24A by printing a silver paste or by etching an aluminum foil or a copper foil formed on the surface of the PET film 24A, for example.

The IC chip 23 is mounted on the surface of the PET film 24A and is electrically connected to the antenna 22. The IC chip 23 includes a memory chip and stores data representing a unique identification (ID) in the memory chip. The IC chip 23 is similar to the IC chip 13 of the first comparative example and the ID is read by a reader/writer of the RFID tag 20.

The antenna 22 and the IC chip 23 are mounted on a surface of the PET film 24A. The PET film 24A is adhered to a top surface of the spacer 21 in a state where the antenna 22 is formed on the surface of the PET film 24A and the IC chip 23 is mounted on the surface.

The PET film 24B is attached to a bottom surface of the spacer 21 in a state where the electromagnetic wave reflector 26 is formed on a surface (a bottom surface as illustrated in FIG. 2A) of the PET film 24B.

The cover 25 covers entire surfaces of the spacer 21, the antenna 22, the IC chip 23 and the PET film 24A. The cover 25 is made of rubber.

The electromagnetic wave reflector 26 is provided in order to reflect electromagnetic waves radiated from the antenna 22. The RFID tag 20 includes the electromagnetic wave reflector 26 disposed on the bottom surface 20A and heightens the antenna 22 so that the RFID tag 20 can perform communications through the antenna 22 in a case where the RFID tag 20 is attached to a metal product, a container which can contain an object that reflects or absorbs electromagnetic waves or the like.

FIG. 2B is a diagram illustrating a cross-sectional view of the RFID tag 20 in a state where the RFID tag 20 is bent.

In FIG. 2B, the RFID tag 20 is bent so that the bottom surface 20A is made concave, i.e. the bottom surface 20A is curved upward toward the middle. A situation as described above corresponds to a case where the RFID tag 20 is attached to a lateral surface of a bottle having a cylindrical shape, for example.

Since the PET film 24B does not shrink, a convex portion 20B appears in the middle of the bottom surface 20A in a case where the RFID tag 20 is attached to a curved surface. Since the PET film 24B is forced downward, the convex portion 20B appears.

If the convex portion 20B appears, it becomes difficult to attach the RFID tag 20 on the curved surface.

If the spacers 11 and 21 of the RFID tags and 20 are made thinner, following problems may occur in a case where the RFID tags 10 and 20 are attached to the curved surface.

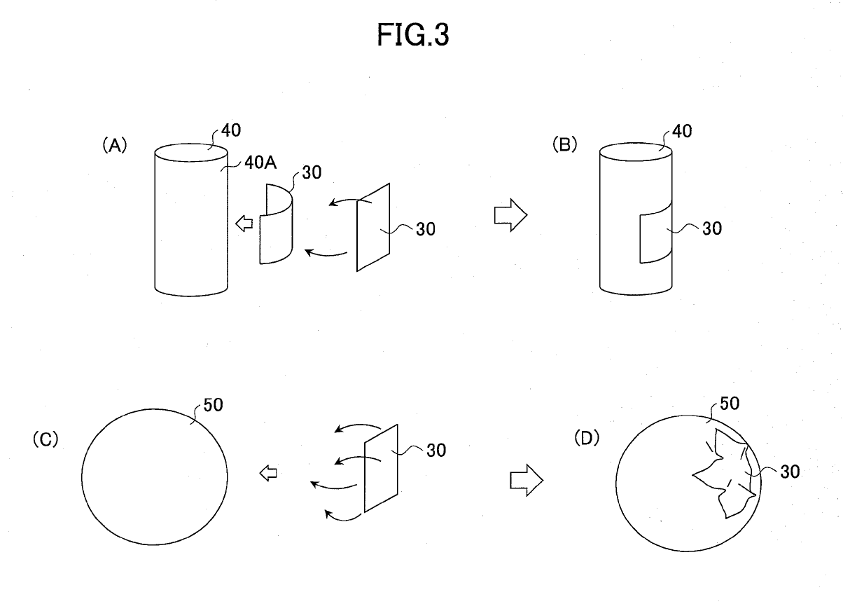

FIG. 3 is a diagram illustrating states where a thin RFID tag 30 is attached to curved surfaces.

The RFID tag 30 is obtained by making the spacer 11 or 21 of the RFID tag 10 or 20 thinner.

In a case of trying to attach the RFID tag 30 on a lateral surface 40A of a product 40 having a cylindrical shape as illustrated in part (A) of FIG. 3, the RFID tag 30 can be attached to the lateral surface 40A in a state where the RFID tag 30 is bent in accordance with a degree of curvature of the lateral surface 40A as illustrated in part (B) of FIG. 3.

However, in a case of trying to attach the RFID tag 30 on a surface of a product 50 having a spherical shape as illustrated in part (C) of FIG. 3, wrinkles appear on the RFID tag 30 as illustrated in part (D) of FIG. 3. Accordingly, it is difficult to attach the RFID tag 30 on a surface such as the spherical surface. The same applies to a surface of a cylindrical body having non-constant diameters and the like, for example.

As described above, it is difficult to attach the RFID tag 30 obtained by making the RFID tags 10 and 20 thinner on a surface having a complicated shape such as the spherical surface, for example. This is because the PET films 14 and 24B do not shrink.

Herein, it may be conceivable to substitute soft members such as foam or sponges for the spacers 11 and 21 in order to absorb the convex portions 10B and 20B, respectively.

However, the members such as foam or sponges including air bubbles have low dielectric constant. Accordingly, such members are not suitable for downsizing of an antenna. Since the members include the air bubbles, the dielectric constant of the members may not be constant, and communication characteristics of the RFID tag 30 may be affected.

Accordingly, it is desirable for each of the spacers 11 and 21 to have a certain high level of dielectric constant and to have a constant dielectric constant.

Therefore, it is an object of first to fourth embodiments as will be described hereinafter to provide an RFID tag which can be attached on the curved surface easily.

### First Embodiment

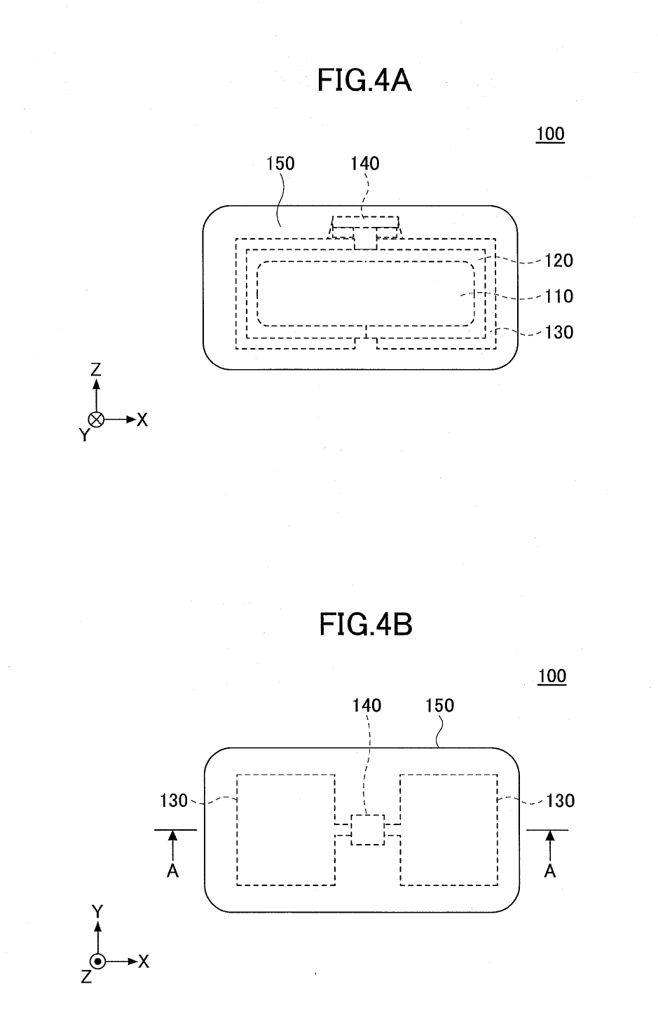

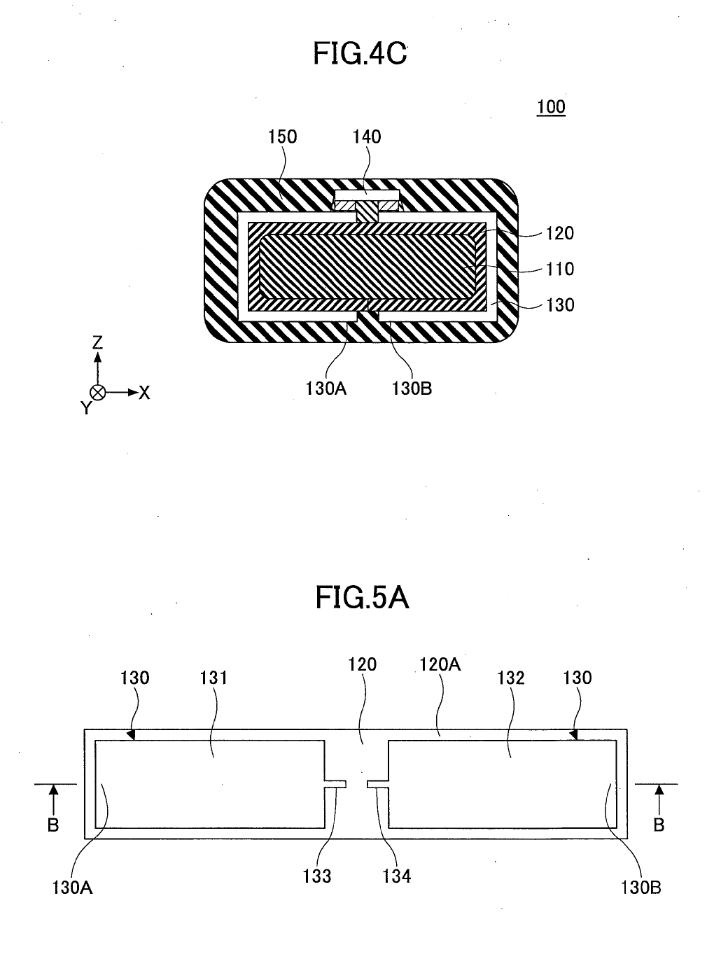

FIG. 4A is a diagram illustrating an RFID tag 100 according to the first embodiment in side view. FIG. 4B is a diagram illustrating the RFID tag 100 in plan view. FIG. 4C is a diagram illustrating a cross section of the RFID tag 100 taken along A-A line illustrated in FIG. 4B. XYZ coordinate systems as orthogonal coordinate systems are defined as illustrated in FIGS. 4A to 4C.

The RFID tag 100 includes a spacer 110, a base part 120, an antenna 130, an IC chip 140 and a cover 150. In the side view and the cross-sectional view as illustrated in FIGS. 4A and 4C, respectively, the IC chip 140 and peripheral portions thereof are enlarged compared with FIG. 4B. In side views and cross-sectional views of other figures as will be illustrated hereinafter, the IC chip 140 and peripheral portions thereof are enlarged in a similar fashion.

The spacer 110 is provided in order to form the antenna 130 in a three-dimensional shape and to heighten the antenna 130 with respect to a surface of a product to which the RFID tag 100 is attached.

A member which has entropic elasticity may be used as the member which constitutes the spacer 110 having flexibility and elasticity, for example. The entropic elasticity includes rubber elasticity and elastomer elasticity, for example. Thus, for example, rubber material which has rubber elasticity or elastomer material which has elastomer elasticity may be used as material of the spacer 110 having flexibility and elasticity.

A silicone (silica-ketone) rubber, butyl rubber, a nitrile rubber, a nitrile hydride rubber, a fluoride rubber, an epichlorohydrin rubber, an isoprene rubber, a chlorosulfonated polyethylene rubber or a urethane rubber may be used as the rubber material, for example.

An elastomer of vinyl chloride series, styrene series, olefin series, ester series, urethane series or amide series may be used as the elastomer material, for example.

Herein, the material of the spacer 110 is not limited to a member which is made of the materials described above and is not limited to the member which has entropic elasticity, as long as the material of the spacer 110 has flexibility and elasticity.

The base part 120 is a sheet-shaped member having flexibility and elasticity, and is one example of a sheet part. The antenna 130 is formed onto one of the surfaces of the base part 120. The IC chip 140 is mounted on the same surface of the base part 120 as the one onto which the antenna 120 is formed.

The base part 120 is formed by calendering performed by the calender machine or extrusion etc.

A member which has entropic elasticity may be used as the member which constitutes the base part 120 having flexibility and elasticity, for example. The entropic elasticity includes rubber elasticity and elastomer elasticity, for example. Thus, for example, rubber material which has rubber elasticity or elastomer material which has elastomer elasticity may be used as material of the member having flexibility and elasticity which constitutes the base part 120.

A rubber material similar to the rubber material of the spacer 110 may be used as a rubber material of the base part 120.

Herein, the material of the base part 120 is not limited to a member which is made of the materials described above and is not limited to the member which has entropic elasticity, as long as the material of the base part 120 has flexibility and elasticity.

A shrinkage rate (shrinkage percentage) of the base part 120 is set to be a designated shrinkage rate between a shrinkage rate of the spacer 110 and a shrinkage rate of the antenna 130.

The antenna 130 is formed on one of the surfaces of the base part 120. The antenna 130 has flexibility and elasticity and includes conducting particles.

The antenna 130 is formed of a silver paste having flexibility and elasticity, for example. The antenna 130 is formed in a loop shape as illustrated in FIG. 4C by adhering the base part 120 on the top surface, the bottom surface and both lateral surfaces of the spacer 110 in a state where the antenna 130 is formed on the surface of the base part 120 having the sheet shape.

Although ends 130A and 130B of the antenna 130 may be apart from each other as illustrated in FIG. 4C, the ends 130A and 130B may be connected to each other. Otherwise, the ends 130A and 130B may be overlapped with each other. Although the ends 130A and 130B are separated by a narrow gap as illustrated in FIG. 4C, the antenna 130 becomes an antenna having a loop shape, since a high-frequency current is flowing through the antenna 130.

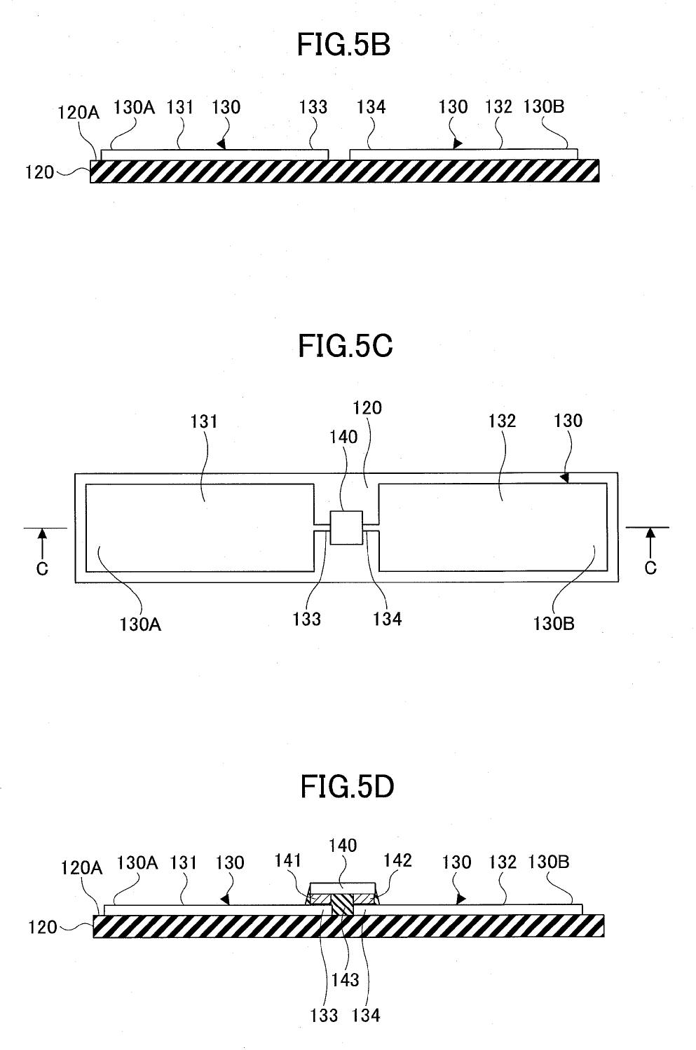

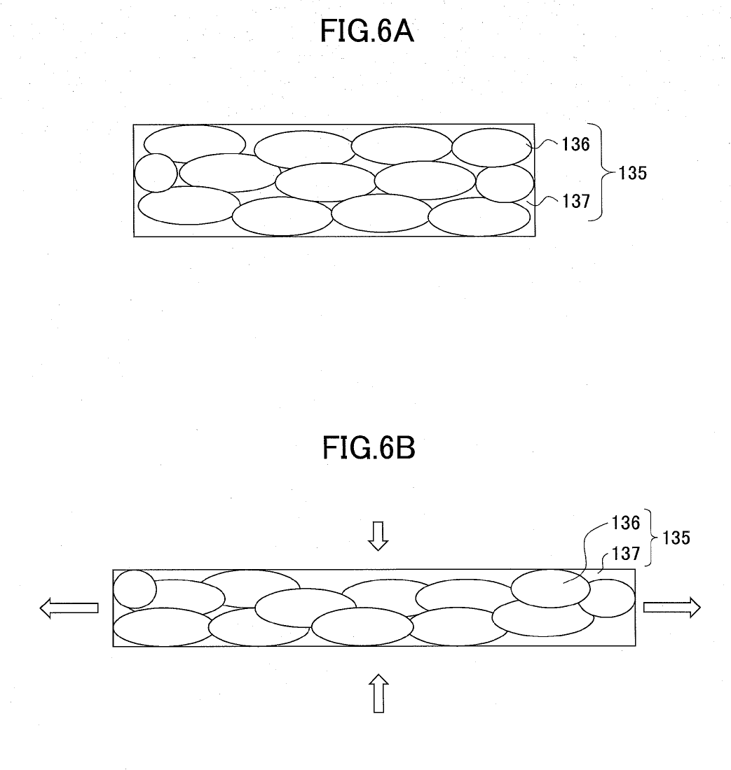

A shape of the antenna 130 will be described hereinafter with reference to FIGS. 5A to 5D. The material of the antenna 130, i.e. the silver paste, and a method for forming the antenna 130 will be hereinafter described in detail with reference to FIG. 6.

The IC chip 140 is mounted on the surface of the base part 120 and is connected to the antenna 130.

When the IC chip 140 receives a read signal in a radio frequency (RF) band from a reader/writer of the RFID tag 100 via the antenna 130, the IC chip 140 is activated by power of the read signal and transmits identification data (ID) via the antenna 130. Accordingly, the reader/writer can read the ID of the RFID tag 100.

The cover 150 is a member having flexibility and elasticity, and is one example of a cover part. As illustrated in FIGS. 4A to 4C, the cover 150 covers entire surfaces of the spacer 110, the base part 120, the antenna 130 and the IC chip 140. This is for the sake of protecting the spacer 110, the base part 120, the antenna 130 and the IC chip 140.

The cover 150 may be constituted of a member having flexibility and elasticity, similar to the spacer 110 and the base part 120.

A member which has entropic elasticity may be used as the member having flexibility and elasticity, for example. The entropic elasticity includes rubber elasticity and elastomer elasticity, for example. Thus, for example, rubber material which has rubber elasticity or elastomer material which has elastomer elasticity may be used as material of the cover 150 having flexibility and elasticity.

The rubber materials of the cover 150, the spacer 110 and the base part 120 may be different from each other.

Herein, hardness of the members of the spacer 110, the base part 120 and the cover 150 may be set as the rubber hardness, for example.

For example, the rubber hardness of the spacer 110, the base part 120 and the cover 150 may be set to about JIS A 70 or JIS A 80, for example. Herein, JIS A 70 and JIS A 80 represent hardnesses of rubbers under Japanese Industrial Standardization (JIS) Law.

The spacer 110, the base part 120 and the cover 150 may have the same rubber hardness. Any two of the spacer 110, the base part 120 and the cover 150 may have the same rubber hardness. The spacer 110, the base part 120 and the cover 150 may have different rubber hardnesses from each other.

In the following, the antenna 130 formed on the surface of the base part 120 and the IC chip 140 mounted on the surface of the base part 120 will be described with reference to FIGS. 5A to 5D.

FIG. 5A is a diagram illustrating the antenna 130 of the RFID tag 100 according to the first embodiment in plan view. FIG. 5B is a diagram illustrating a cross section taken along B-B line as illustrated in FIG. 5A.

FIG. 5C is a diagram illustrating the antenna 130 and the IC chip 140 of the RFID tag 100 according to the first embodiment in plan view. FIG. 5D is a diagram illustrating a cross section taken along C-C line as illustrated in FIG. 5C.

As illustrated in FIG. 5A, the antenna 130 is formed on a surface 120A of the base part 120 by printing the silver paste having flexibility and elasticity, for example. The antenna 130 is a type of a dipole antenna and includes antenna portions 131 and 132.

Lengths of the antenna portions 131 and 132 may be set corresponding to a communication frequency of the RFID tag 100. Since a frequency band ranging from 952 MHz to 954 MHz and a frequency band of 2.45 GHz are assigned for the communication of RFID tags in Japan, for example, length of the antenna portions 131 and 132 between the edges 130A and 130B may be set to half wavelength where the wavelength A is obtained at the communication frequency of the RFID tag 100. Since frequency bands of 915 MHz and 868 MHz are assigned for the RFID tags in the United States and Europe (EU) respectively, for example, the length of the antenna portions 131 and 132 may be set to a half wavelength where the wavelength A at the communication frequency of the RFID tag 100.

A pair of communication terminals of the IC chip 140 that are connected to the antenna 130 are connected respectively to a terminal 133 of the antenna portion 131 and a terminal 134 of the antenna portion 132.

As illustrated in FIG. 5D, the communication terminals of the IC chip 140 are connected to the antenna 130 by mounting the IC chip 140 on the surface 120A of the base part 120 by a flip-chip bonding technique. The IC chip 140 is connected to the terminals 133 and 134 of the antenna 130 via bumps 141 and 142.

Since the IC chip 140 is connected to the base part 120 via an underfill part 143, the terminals 133 and 134 are connected to the bumps 141 and 142 and thereby the antenna 130 is electrically connected to IC chip 140.

In the following, a silver paste 135 used for forming the antenna 130 is described with reference to FIGS. 6A and 6B.

FIG. 6A is a diagram illustrating a configuration of the silver paste 135 used for forming the antenna 130 of the RFID tag 100 according to the first embodiment. FIG. 6B is a diagram illustrating the silver paste 135 in a state of being pulled sideways.

The silver paste 135 which includes silver particles 136 and a binder 137 is one example of conducting paste. The silver particles 136 are one example of conducting particles. In FIG. 6, circles represent the silver particles 136, and portions that exist around the silver particles 136 represent the binder 137.

The binder 137 may be a member having flexibility and elasticity. A silicone (silica-ketone) rubber, a butyl rubber, a nitrile rubber, a nitrile hydride rubber, a fluoride rubber, an epichlorohydrin rubber, an isoprene rubber, a chlorosulfonated polyethylene rubber or a urethane rubber may be used as the binder 137, for example. The silver particles 136 are mixed with the binder 137.

The reason why the member having flexibility and elasticity is used as the binder 137 is that it becomes possible to attach the RFID tag 100 on a complicated curved surface such as a spherical surface easily by giving the flexibility and elasticity to the antenna 130.

The antenna 130 is formed by printing the silver paste 135 on the surface 120A of the base part 120 and then thermally-hardening the binder 137. Since the thermally-hardened silver paste has flexibility and elasticity, it is possible to form the antenna 130 having flexibility and elasticity.

If the antenna 130 is pulled sideways, the silver paste 135 is pulled sideways as indicated by arrows illustrated in FIG. 6B. As a result, a compressing force acts on the silver paste 135 in a vertical direction. Therefore, the silver particles 136 are kept in physical contact with each other. Accordingly, the antenna 130 is not going to be broken and a function of the antenna 130 is kept, if the RFID tag 100 is attached on the complicated curved surface such as the spherical surface or the like.

Although the silver paste 135 including the silver particles 136 as the conducting particles is described above, a copper paste including copper particles as the conducting particles or a nickel paste including nickel particles as the conducting particles may be used instead of the silver paste 135.

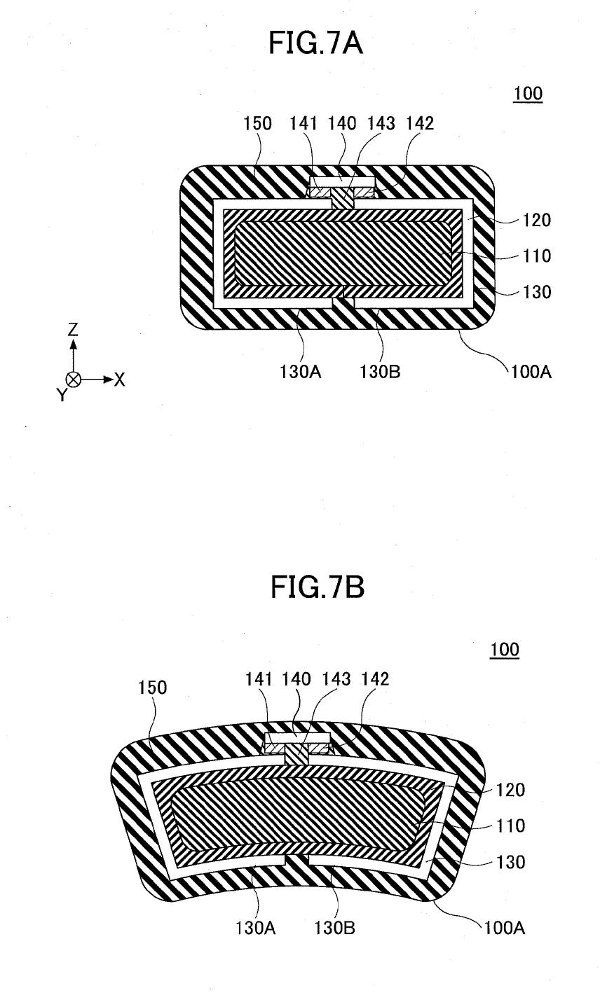

FIG. 7A is a diagram illustrating a cross section of the RFID tag 100 in a normal state. FIG. 7B is a diagram illustrating a cross section of the RFID tag 100 bent along a longitudinal direction.

In the normal state, no stress is acting on the RFID tag 100. The cross section of the RFID tag 100 as illustrated in FIG. 7A corresponds to the cross section as illustrated in FIG. 4C.

If the RFID tag 100 as illustrated in FIG. 7A is bent so that the bottom surface 100A becomes a concave surface as illustrated in FIG. 7B, the bottom surface 100A is bent smoothly in a recessed shape. Accordingly, a convex portion such as the convex portion 10B or 20B of the RFID tag 10 or 20 according to the first or the second comparative example does not appear anywhere in the RFID tag 100.

In the RFID tag 100, the spacer 110, the base part 120 and the cover 150 are constituted of the members having flexibility and elasticity, and the antenna 130 is formed of the silver paste 135 including the silver particles 136 mixed with the binder 137 having flexibility and elasticity.

If the RFID tag 100 is bent so that the bottom surface 100A becomes the concave surface, the spacer 110, the base part 120, the antenna 130 and the cover 150 shrink on a side of the bottom surface 100A. Accordingly, a convex portion such as the convex portion 10B or 20B of the RFID tag 10 or 20 according to the first or the second comparative example does not appear anywhere in the RFID tag 100.

Although the RFID tag 100 is bent along one axis for the purpose of illustration in FIG. 7B, the convex portion does not appear anywhere in the RFID tag 100 in a case where the RFID tag 100 is bent in a complicated shape along more than two axes.

Accordingly, it is possible to attach the RFID tag 100 according to the first embodiment to complicated curved surface(s) such as spherical surfaces of hemispheres having various radii, a lateral surface of a cylindrical body having various radii along the central axis, a curved surface having concavities or convexities and the like.

Herein, a curvature of a spherical surface varies in accordance with a radius the spherical surface. Accordingly, it is possible to prepare a curved RFID tag which is bent in accordance with a curvature of a spherical surface of a product by using a material which does not have flexibility and elasticity in advance. Moreover, it is possible to prepare a curved RFID tag which is bent in accordance with curvatures of surfaces having various shapes other than the spherical surface by using the material which does not have flexibility and elasticity in advance.

However, the curved RFID tag as described above made of the material which does not have flexibility and elasticity can be attached only to the spherical surface or the curved surface.

In contrast, it is possible to attach the RFID tag 100 according to the first embodiment to complicated curved surface(s) such as spherical surfaces of hemispheres having various radii, a lateral surface of a cylindrical body having various radii along the central axis, a curved surface having concavities or convexities and the like. Therefore, it is not necessary to manufacture the RFID tag 100 for each product. The RFID tag 100 has enhanced design efficiency and enhanced manufacture efficiency.

Since the RFID tag 100 can be attached to various curved surfaces easily and universally, it is possible to reduce manufacturing cost of the RFID tag 100 considerably.

Although the RFID tag 100 is bent so that the bottom surface 100A becomes the concave surface in FIG. 7B, the same applies to a case where the RFID tag 100 is bent so that the bottom surface 100A becomes a convexed surface.

In the following, the method for manufacturing the RFID tag 100 according to the first embodiment is described.

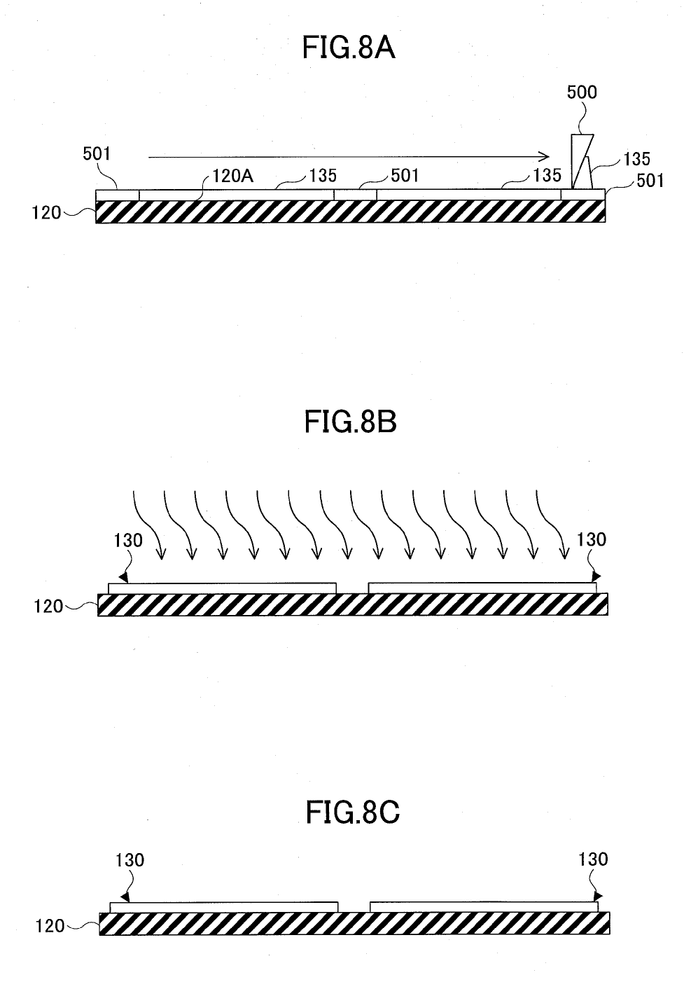

FIGS. 8A, 8B, 8C, 9A, 9B, 9C, 9D, 10A, 10B, 10C and 10D are diagrams illustrating manufacturing processes of the RFID tag 100 according to the first embodiment. In these figures, cross sections corresponding to those illustrated in FIGS. 4C, 5B and 5D are illustrated.

At first, as illustrated in FIG. 8A, the silver paste 135 is coated on the surface 120A of the base part 120 by performing a screen printing which utilizes a squeegee 500 and a stencil 501. The stencil 501 is patterned corresponding to the antenna portions 131 and 132 as illustrated in FIG. 5A.

Next, as illustrated in FIG. 8B, the binder 137 (see FIG. 6A) included in the silver paste 135 is thermally-hardened by performing a heating process.

As a result, the antenna 130 is completed as illustrated in FIG. 8C. The antenna 130 has the same pattern as the one illustrated in FIG. 5A.

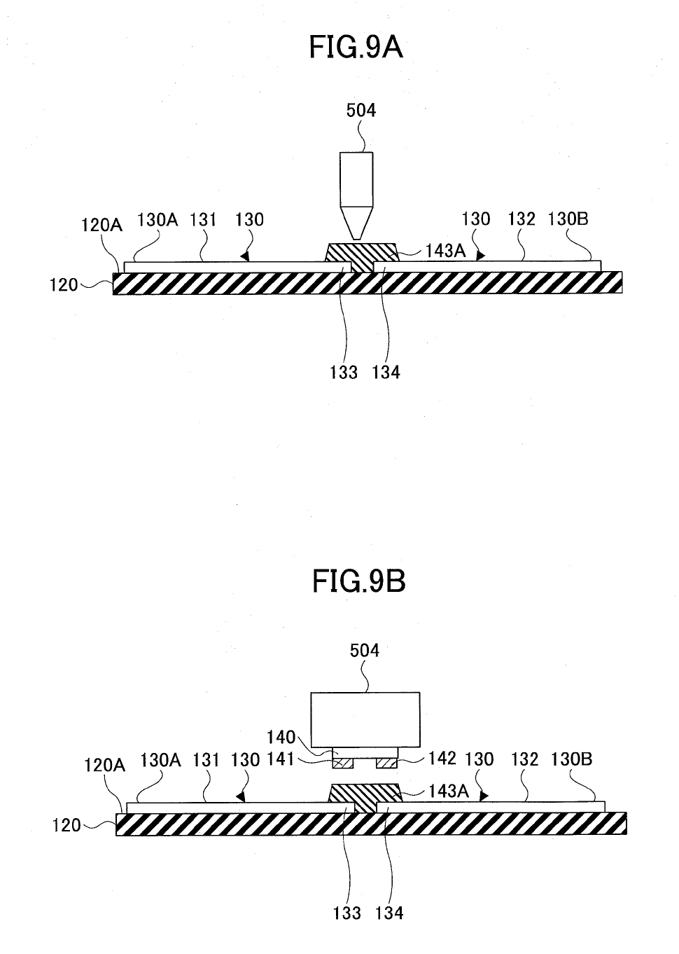

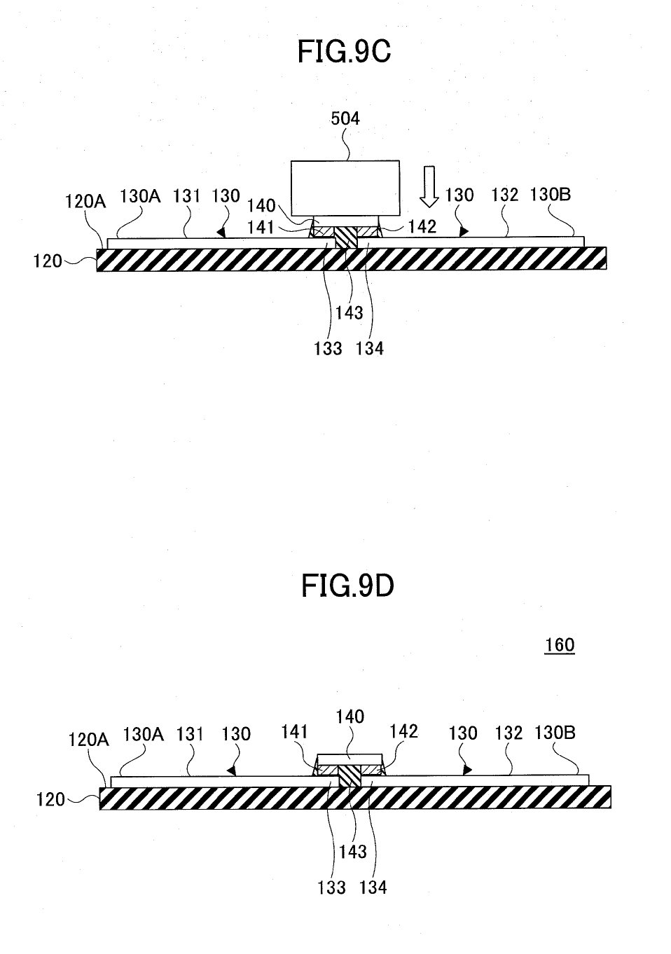

Next, as illustrated in FIG. 9A, an adhesion bond 143A is applied on the terminal 133 of the antenna portion 132 and the terminal 134 of the antenna portion 132 and to an area between the terminal 133 and the terminal 134 by using a dispenser 503.

Next, as illustrated in FIG. 9B, the IC chip 140 to which the bumps 141 and 142 are attached is aligned with respect to the terminals 133 and 134 and is mounted on the adhesion bond 143A by using a bonding tool 504.

Next, as illustrated in FIG. 9C, the IC chip 140 is pressed downward by the bonding tool 504 and the heating process is performed so that the adhesion bond 143A is thermally hardened and the underfill part 143 is obtained.

As a result, a module 160 as illustrated in FIG. 9D is completed. The module 160 has the same configuration as the one illustrated in FIG. 5D. In the module 160, the antenna 130 is formed on the surface 120A of the base part 120 and the IC chip 140 is mounted on the surface 120A. The module 160 constitutes an inlay of the RFID tag 100.

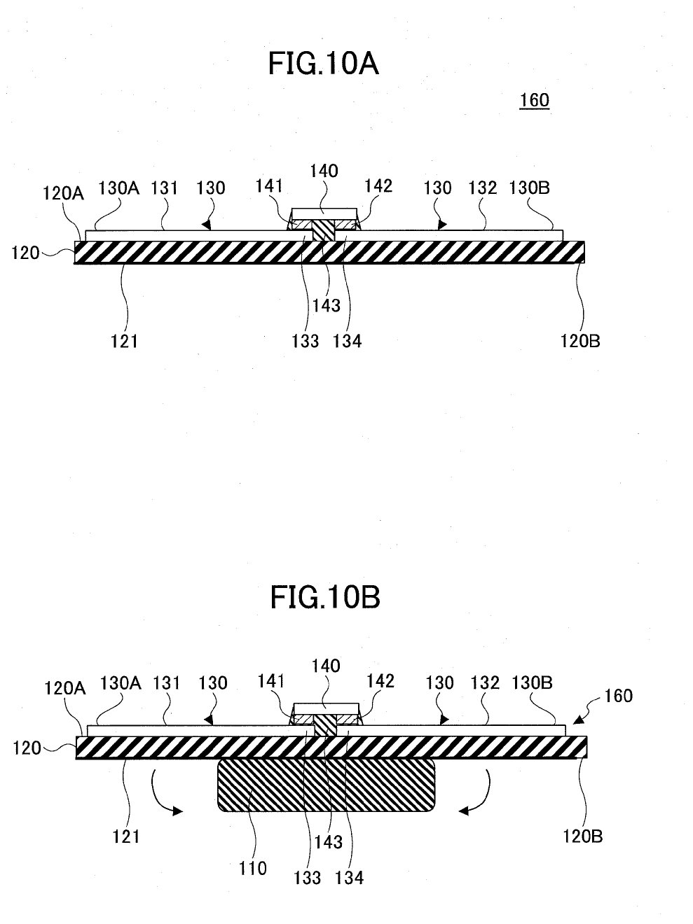

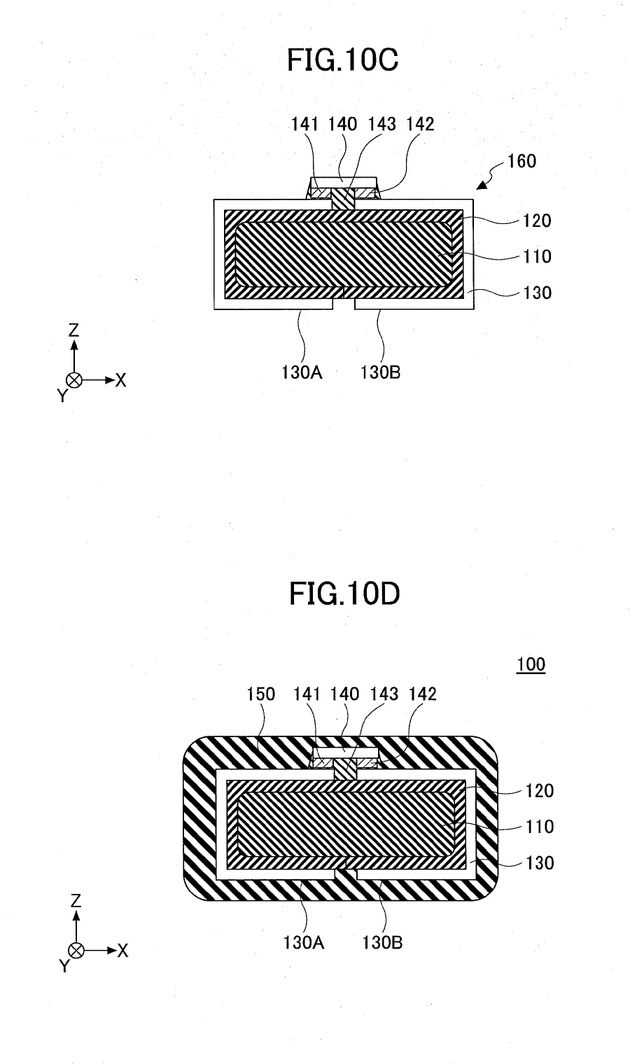

Next, as illustrated in FIG. 10A, a double-faced adhesive tape 121 is attached on a bottom surface 120B of the base part 120 on the module 160.

Then, as illustrated in FIG. 10B, the module 160 is attached on the top surface, both lateral surfaces and the bottom surface of the spacer 110 via the double-faced adhesive tape 121.

Accordingly, as illustrated in FIG. 10C, the attachment of the module 160 on the top surface, both lateral surfaces and the bottom surface of the spacer 110 is completed. At this stage, the antenna 130 is formed in the loop shape.

Finally, as illustrated in FIG. 10D, the cover 150 is attached around the spacer 110 and the module 160 in order to complete the RFID tag 100 according to the first embodiment. The cover 150 is formed by performing insert molding so that the member having flexibility and elasticity covers the spacer 110 and the module 160.

According to the first embodiment, the RFID tag 100 which can be attached to the complicated curved surface(s) such as spherical surfaces of hemispheres having various radii, a lateral surface of a cylindrical body having various radii along the central axis, a curved surface having concavities or convexities and the like is provided.

Since the RFID tag 100 includes the antenna 130 having a three-dimensional loop shape, the RFID tag 100 can perform communications through the antenna 130 in a case where the RFID tag 100 is attached to a metal product, a container which can contain the object that reflects or absorbs electromagnetic waves or the like. The RFID tag 100 can lengthen a communication distance.

Accordingly, it is possible to attach the RFID tag 100 on lateral surfaces of metal cans having various diameters, for example.

According to the embodiment as described above, the RFID tag 100 is manufactured by attaching the base part 120 on which the antenna 130 is formed and the IC chip 140 is mounted on the top surface, both lateral surfaces and the bottom surface of the spacer 110.

However, the antenna 130 may be directly formed on the top surface, both lateral surfaces and the bottom surface of the spacer 110 and the IC chip 140 may be directly mounted on the top surface of the spacer 110 without including the base part 120.

Although the spacer 110 has a cuboid shape as described above, the spacer 110 may have curved lateral surfaces similar to the spacer 11 of the first comparative example, for example.

### Second Embodiment

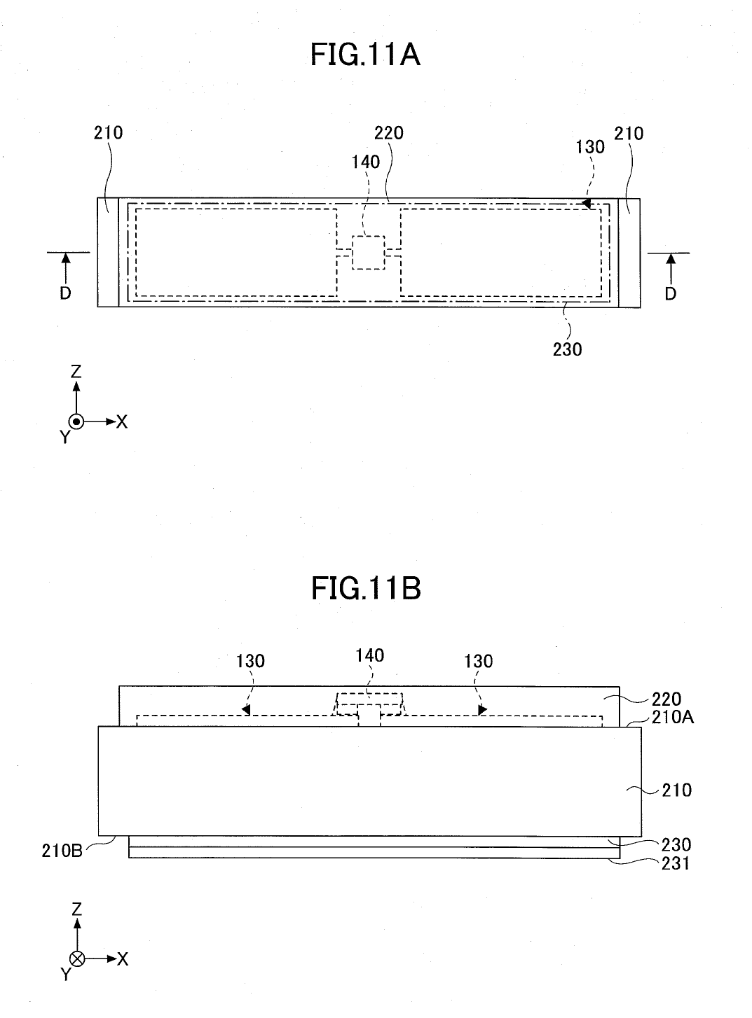

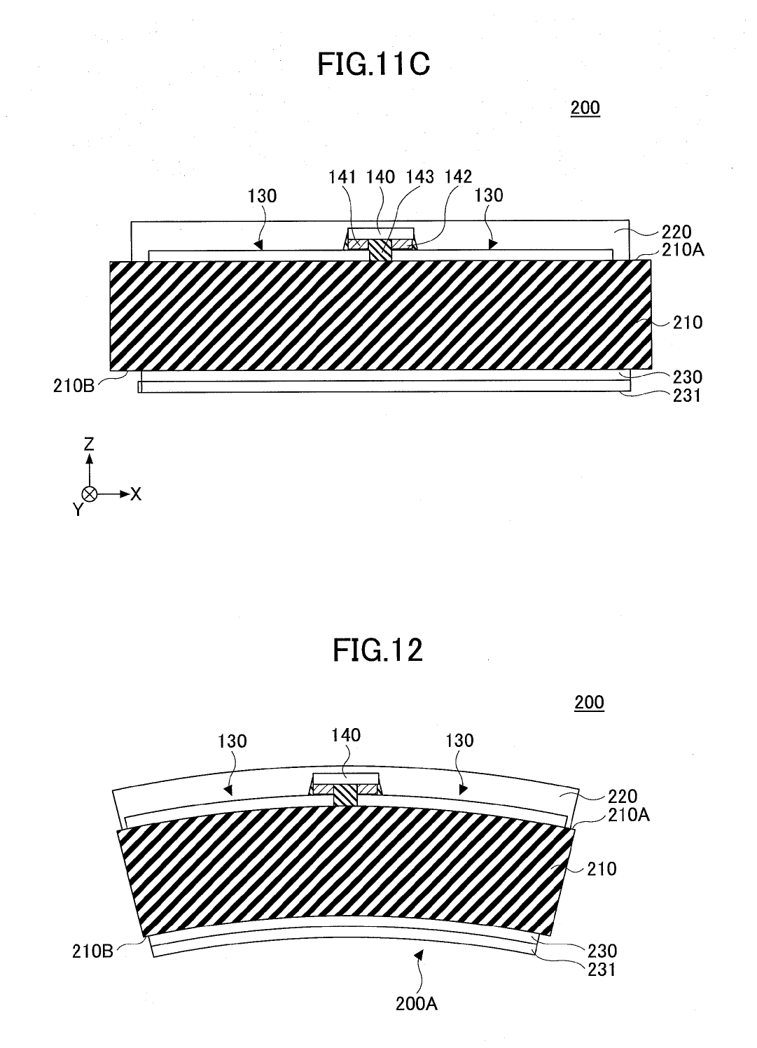

FIG. 11A is a diagram illustrating an RFID tag 200 according to the second embodiment in plan view. FIG. 11B is a diagram illustrating the RFID tag 200 in side view. FIG. 11C is a diagram illustrating a cross section of the RFID tag 200 taken along D-D line illustrated in FIG. 11A.

FIG. 11C illustrates the RFID tag 200 in a normal state. In the normal state, no stress is acting on the RFID tag 200. XYZ coordinate systems as orthogonal coordinate systems are defined as illustrated in FIGS. 11A to 11C.

Hereinafter, the same elements as or elements similar to those of the RFID tag 100 of the first embodiment are referred to by the same reference numerals, and a description thereof is omitted.

The RFID tag 200 includes a spacer 210, an antenna 130, an IC chip 140, a cover 220 and an electromagnetic wave reflector 230. In FIGS. 11B and 11C, a double-faced adhesive tape 231 is attached on a bottom surface of the electromagnetic wave reflector 230.

The spacer 210 is constituted of a member having flexibility and elasticity which is similar to that of the spacer 110 of the first embodiment. Since the antenna 130 of the RFID tag 200 is not bent in a loop shape and spreads on a top surface 210A of the spacer 210, the spacer 210 is larger than the spacer 11 of the first embodiment in plan view.

In the RFID tag 200, the antenna 130 is directly formed on the top surface 210A of the spacer 210. The IC chip 140 is directly mounted on the top surface 210A of the spacer 210.

The antenna 130 and the IC chip 140 are covered by the cover 220.

The electromagnetic wave reflector 230 is directly formed on a bottom surface 210B of the spacer 210. The electromagnetic wave reflector 230 is provided in order to reflect electromagnetic waves radiated from the antenna 130. The electromagnetic wave reflector 230 is formed of a silver paste having flexibility and elasticity which is similar to the silver paste of the antenna 130.

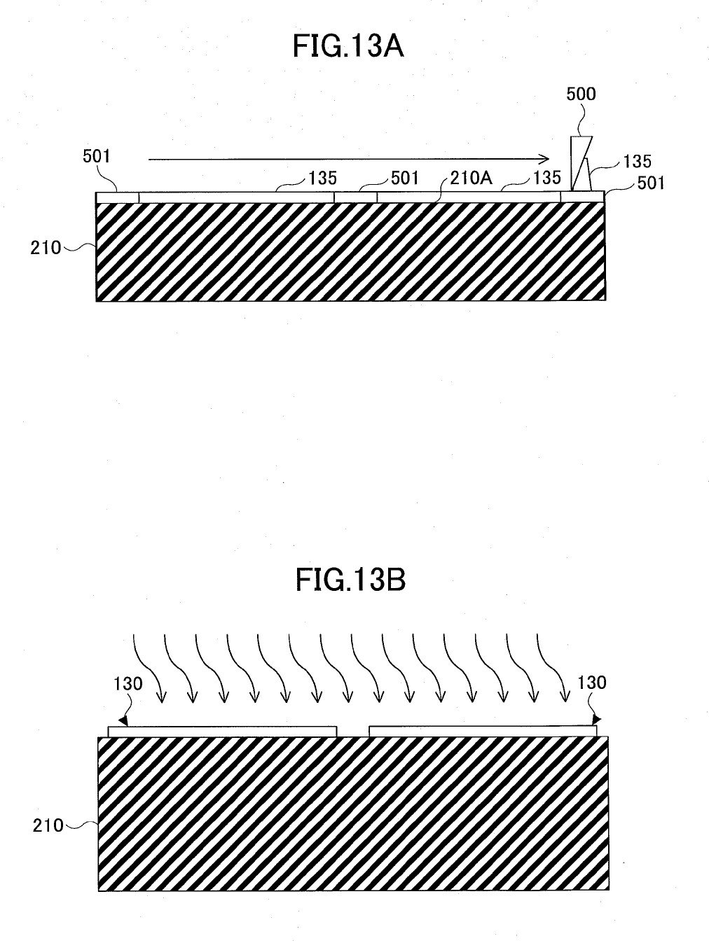

FIG. 12 is a diagram illustrating a cross section of the RFID tag 200 bent along a longitudinal direction.

If the RFID tag 200 as illustrated in FIG. 11C is bent so that a bottom surface 200A becomes a concave surface as illustrated in FIG. 12, the bottom surface 200A is bent smoothly in a recessed shape. Accordingly, a convex portion such as the convex portion 10B or 20B of the RFID tag 10 or 20 according to the first or the second comparative example does not appear anywhere in the RFID tag 200.

In the RFID tag 200, the spacer 210 and the cover 220 are constituted of the members having flexibility and elasticity, and the antenna 130 and the electromagnetic wave reflector 230 are formed of the silver paste 135 including the silver particles 136 mixed with the binder 137 having flexibility and elasticity.

If the RFID tag 200 is bent so that the bottom surface 200A becomes the concave surface, the spacer 210, the antenna 130, the electromagnetic wave reflector 230 and the cover 220 shrink on a side of the bottom surface 200A. Accordingly, a convex portion such as the convex portion 10B or 20B of the RFID tag 10 or 20 according to the first or the second comparative example does not appear anywhere in the RFID tag 200.

Although the RFID tag 200 is bent along one axis for the purpose of illustration in FIG. 12, the convex portion does not appear anywhere in the RFID tag 200 in a case where the RFID tag 200 is bent in a complicated shape along more than two axes.

Accordingly, it is possible to attach the RFID tag 200 according to the second embodiment to complicated curved surface(s) such as spherical surfaces of hemispheres having various radii, a lateral surface of a cylindrical body having various radii along the central axis, a curved surface having concavities or convexities and the like.

FIGS. 13A, 13B, 14A, 14B, 15A and 15B are diagrams illustrating manufacturing processes of the RFID tag 200 according to the second embodiment. In these figures, cross sections corresponding to the cross section as illustrated in FIG. 11C are illustrated.

At first, as illustrated in FIG. 13A, the silver paste 135 is coated on the top surface 210A of the spacer 210 by performing screen printing which utilizes a squeegee 500 and a stencil 501. The stencil 501 is patterned corresponding to the antenna portions 131 and 132 as illustrated in FIG. 5A.

Next, as illustrated in FIG. 13B, the binder 137 (see FIG. 6A) included in the silver paste 135 is thermally-hardened by performing a heating process. According to this step, the antenna 130 is completed. The antenna 130 has the same pattern as the one indicated by dashed lines in FIG. 11A.

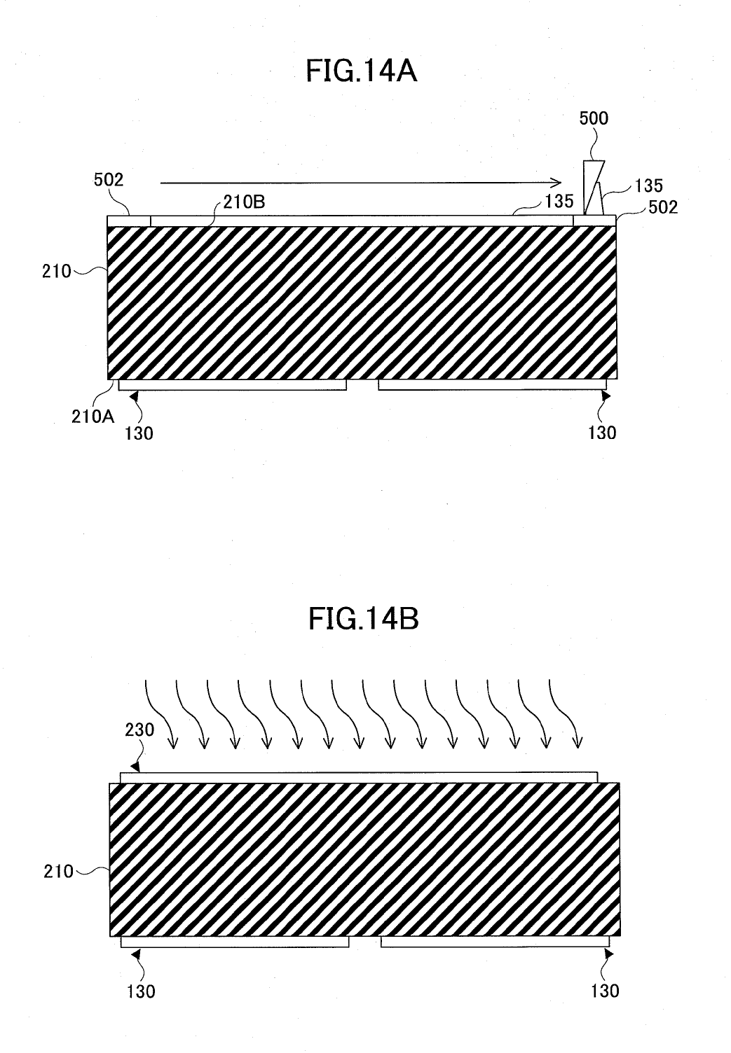

Next, as illustrated in FIG. 14A, the spacer 210 is flipped upside down and the silver paste 135 is coated on the bottom surface 210B of the spacer 210 by performing screen printing which utilizes a squeegee 500 and a stencil 502. The stencil 502 is patterned corresponding to the electromagnetic wave reflector 230. The electromagnetic wave reflector 230 is formed in an area indicated by an alternating long and short dash line as illustrated in FIG. 11A. The area in which the electromagnetic wave reflector 230 is formed includes areas in which the antenna 130 is formed, for example.

The bottom surface 210B of the spacer 210 is located on upper side in FIG. 14A.

Next, as illustrated in FIG. 14B, the binder 137 (see FIG. 6A) included in the silver paste 135 is thermally-hardened by performing a heating process. According to this step, the electromagnetic wave reflector 230 is completed.

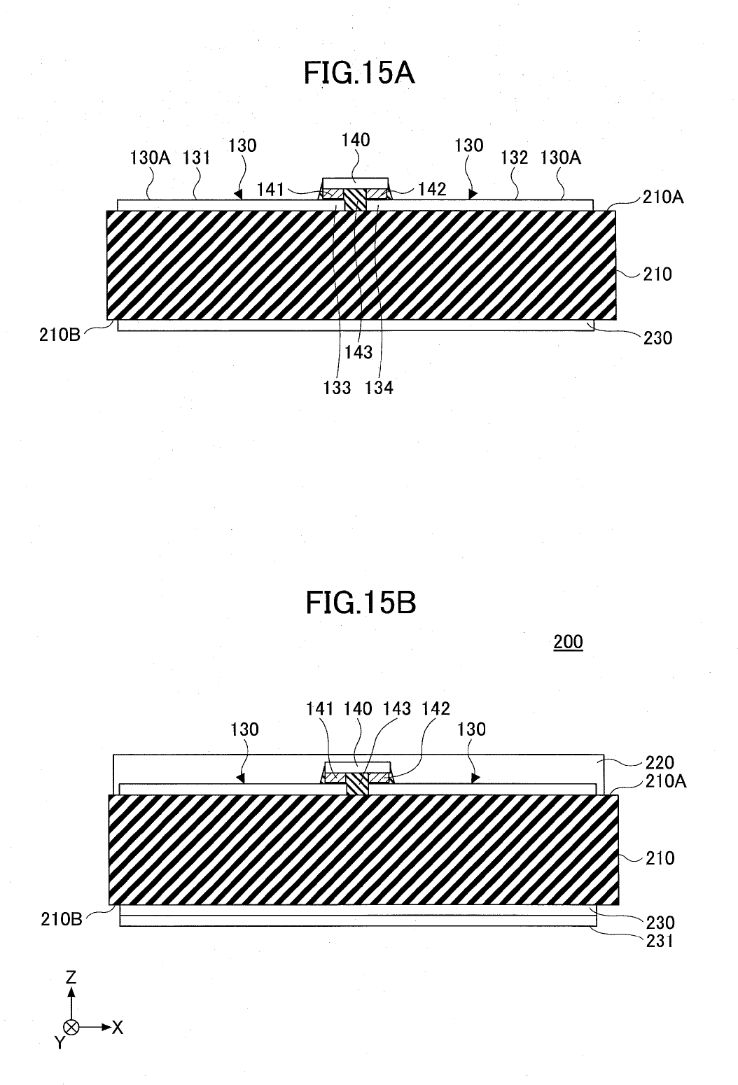

Next, as illustrated in FIG. 15A, the IC chip 140 is mounted on the top surface 210A of the spacer 210. The IC chip 140 is connected to the top surface 210A of the spacer 210 via an underfill part 143. As a result, the bumps 141 and 142 are connected to the terminals 133 and 134 of the antenna 130.

Finally, as illustrated in FIG. 15B, the RFID tag 200 is completed by forming the cover 220 on the antenna 130, the IC chip 140 and the top surface 210A of the spacer 210. The cover 220 is formed by performing insert molding so that the member having flexibility and elasticity covers the antenna 130, the IC chip 140 and the top surface 210A of the spacer 210.

According to the second embodiment, the RFID tag 200 which can be attached to a complicated curved surface(s) such as spherical surfaces of hemispheres having various radii, a lateral surface of a cylindrical body having various radii along the central axis, a curved surface having concavities or convexities and the like is provided.

Since the antenna 130 of the RFID tag 200 is located at a position that is a thickness of the spacer 210 higher than a surface of a product on which the RFID tag 200 is attached and the electromagnetic wave reflector 230 is formed on the bottom surface 210B of the spacer 210, the RFID tag 200 can perform communications through the antenna 130 in a case where the RFID tag 200 is attached to a metal product, a container which can contain the object that reflects or absorbs electromagnetic waves or the like. The RFID tag 200 can lengthen a communication distance.

Accordingly, it is possible to attach the RFID tag 200 on lateral surfaces of metal cans having various diameters, for example.

### Third Embodiment

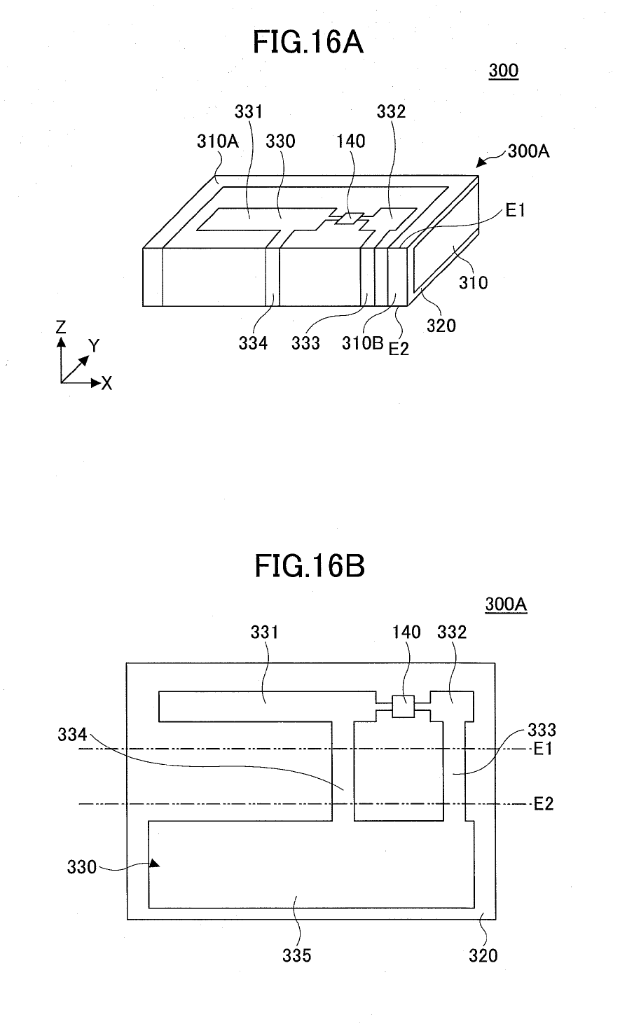

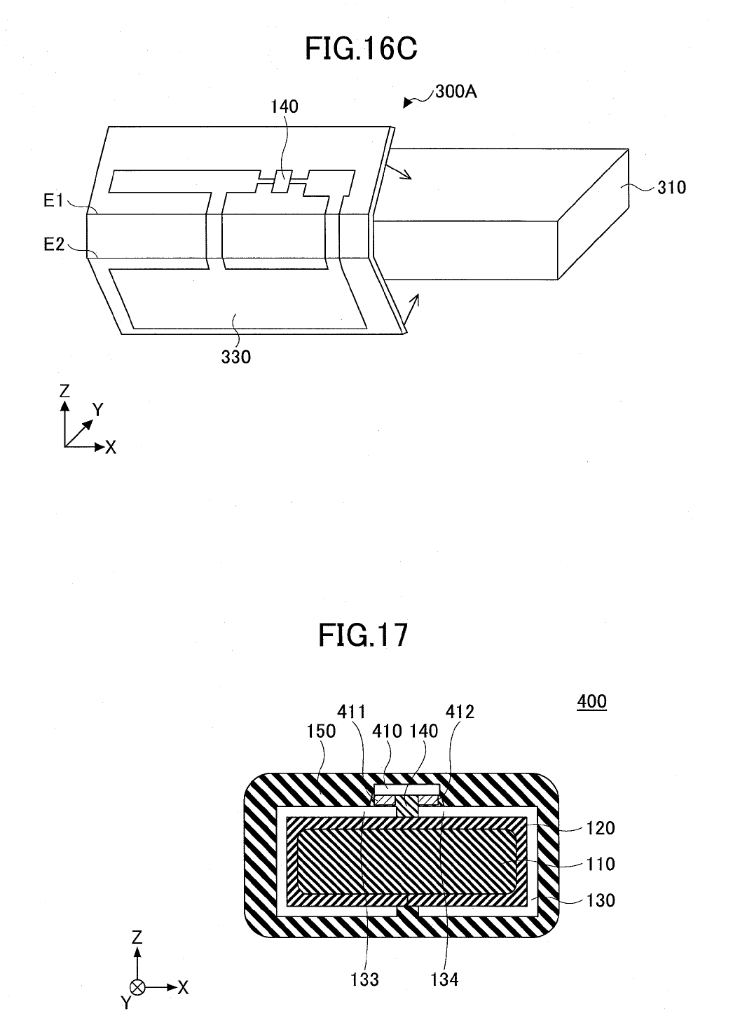

FIG. 16A is a diagram illustrating an RFID tag 300 according to the third embodiment in perspective view. FIG. 16B is a diagram illustrating a module 300A included in the RFID tag 300 in three-surface folded out view. FIG. 16C is a diagram illustrating a manufacturing process of the RFID tag 300.

The RFID tag 300 includes an inverted-F type antenna 330. The inverted-F type antenna 330 is included instead of the antenna 130 of the first and the second embodiments. The antenna 130 is a dipole antenna having a linear shape.

Accordingly, the same elements as or elements similar to those of the RFID tags 100 and 200 of the first and the second embodiments are referred to by the same reference numerals, and a description thereof is omitted. XYZ coordinate systems as orthogonal coordinate systems are defined as illustrated in FIGS. 16A and 16C.

As illustrated in FIG. 16A, the RFID tag 300 includes a spacer 310, a base part 320, an antenna 330 and an IC chip 140.

The spacer 310 is constituted of a member having flexibility and elasticity which is similar to that of the spacer 110 of the first embodiment.

The base part 320 is constituted of a member having flexibility and elasticity which is similar to that of the base part 120 of the first embodiment.

As illustrated in FIG. 16B, the antenna 330 is an inverted-F type antenna formed on a surface of the base part 320. The antenna 330 includes antenna portions 331 to 335. The base part 320 and the antenna 330 are bent along lines E1 and E2, and are adhered on the top surface 310A, a lateral surface 310B and the bottom surface of the spacer 310 as illustrated in FIG. 16A. The lateral surface 310B is located on negative side in Y axis direction. The base part 320 and the antenna 330 are adhered to the spacer 310 so that the base part 320 and the antenna 330 form a U-shape along three surfaces of the spacer 310.

The antenna portions 331 and 332 extend in X axis direction.

The IC chip 140 is inserted between the antenna portions 331 and 332. This is similar to a configuration of the IC chip 140 according to the first embodiment which is inserted between the terminals 133 and 134 of the antenna 130.

The antenna portion 333 is bent from the antenna portion 332 at a right angle in negative Z axis direction. The antenna portion 334 is bent from the antenna portion 331 at a right angle in negative Z axis direction.

The antenna portion 335 is connected to the antenna portions 333 and 334. The antenna portion 335 is placed on the bottom surface (a surface opposite to the top surface 310A) in a state where the base part 320 and the antenna 330 are bent along the lines E1 and E2 and attached to the spacer 310 as illustrated in FIGS. 16A and 16C.

The antenna portions 331 to 334 constitute the inverted-F type antenna which is connected to the antenna portion 335. The antenna portion 335 is placed on the bottom surface of the spacer 310 and functions as an electromagnetic wave reflector. The antenna portion 335 which functions as the electromagnetic wave reflector is similar to the electromagnetic wave reflector 230 of the second embodiment.

According to the third embodiment, it is possible to provide the RFID tag 300 including the inverted-F type antenna 330.

The RFID tag 300 may include a cover which covers the spacer 310, the base part 320, the antenna 330 and the IC chip 140 as illustrated in FIG. 16A.

According to the third embodiment, the RFID tag 300 includes the inverted-F type antenna 330. However, the antenna 330 may be patterned in various shapes.

For example, the antenna 330 may not be shaped in a loop shape constituted by the antenna portions 331 to 335. More specifically, an antenna portion having a rectangular shape may be included instead of the antenna portions 331 to 334. In this case, the antenna 330 is shaped in U-shape located on the top surface, one of the lateral surfaces and the bottom surface of the spacer 310. Since the antenna 330 such as this has the U-shape as viewed from a lateral side, the antenna 330 may be referred to an antenna having a half loop shape.

### Fourth Embodiment

FIG. 17 is a diagram illustrating an RFID tag 400 according to the fourth embodiment in cross-sectional view. The cross section as illustrated in FIG. 17 corresponds that illustrated in FIG. 4C.

The RFID tag 400 is different from the RFID tag 100 of the first embodiment in that the IC chip 140 is mounted on a strap 410, and the strap 410 is attached to the base part 120. Further, the cover 150 of the RFID tag 400 is larger than that of the RFID tag 100 according to the first embodiment.

Otherwise, the RFID tag 400 according to the fourth embodiment is the same as the RFID tag 100 of the first embodiment. Accordingly, the same elements as or elements similar to those of the RFID tag 100 of the first embodiment are referred to by the same reference numerals, and a description thereof is omitted.

The IC chip 140 is mounted on the strap 410 by a flip-chip bonding technique. The strap 410 is connected to the terminals 133 and 134 of the antenna 130 via pads 411 and 412 in a state where the IC chip 140 is mounted on the bottom surface of the strap 410 as illustrated in FIG. 17. The strap 410 may be constituted of a film-like member made of polyethylene. Otherwise, the strap 410 may be constituted of a sheet-shaped member having flexibility and elasticity which is similar to that of the base part 120.

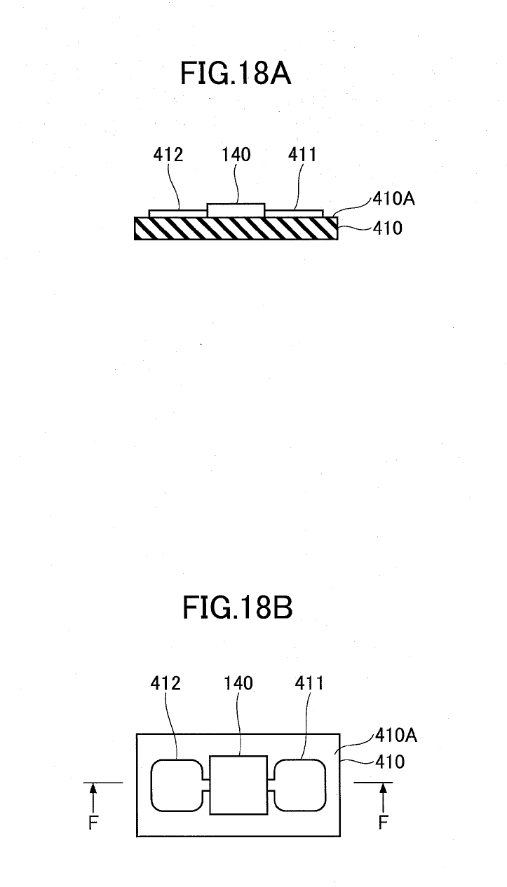

In the fourth embodiment, the IC chip 140 is attached to the base part 120 in a state where the IC chip 140 is flipped upside down compared with the first embodiment. The details are described with reference to FIGS. 18A and 18B.

FIGS. 18A and 18B are diagrams illustrating the strap 410 of the RFID tag 400.

As illustrated in FIGS. 18A and 18B, the strap 410 includes the pads 411 and 412 formed on a surface 410A. The pads 411 and 412 are constituted of copper foils or aluminum foils, for example.

The IC chip 140 is mounted on the strap 410 via bumps by a flip-chip bonding technique in a manner similar the IC chip 140 which is mounted on the base part 120 via the bumps 141 and 142 by the flip-chip bonding technique according to the first embodiment. Communication terminals of the IC chip 140 are connected to the pads 411 and 412 of the strap 410 via the bumps (not illustrated).

The IC chip 140 is mounted on the strap 410 as illustrated in FIG. 18A and the strap 410 is mounted on the base part 120 in a state where the strap 410 is flipped upside down as illustrated in FIG. 17. At this stage, the bumps 411 and 412 are connected to the terminals 133 and 134 of the antenna 130.

According to the fourth embodiment, it is possible to mount the IC chip 140 on the base part 120 via the strap 410.

In the above description, the RFID tag and the RFID tag manufacturing method according to embodiments are described. However, the present invention is not limited to the embodiments specifically disclosed. A person skilled in the art may easily achieve various modification and changes without departing from the scope of the present invention.

The other objects, features, and benefits of the present application may become further clear by referring to the accompanying drawing and embodiments described above.

All examples and conditional language recited herein are intended for pedagogical purposes to aid the reader in understanding the invention and the concepts contributed by the inventors to furthering the art, and are to be construed as being without limitation to such specifically recited examples and conditions, nor does the organization of such examples in the specification relate to a showing of superiority or inferiority of the invention. Although the embodiment of the present invention has been described in detail, it should be understood that various changes, substitutions, and alterations could be made hereto without departing from the sprit and scope of the invention.

What is claimed is:

1. An RFID tag comprising:
a spacer made of a first member having flexibility and elasticity, the spacer having a top surface, a lateral surface and a bottom surface;
an antenna made of a conductive material having flexibility and elasticity and disposed on the top surface, the lateral surface and the bottom surface of the spacer; and
an IC chip electrically connected to the antenna.

2. The RFID tag as claimed in claim 1, further comprising:
a sheet part made of a second member having flexibility and elasticity, the sheet part having a sheet shape;
wherein the antenna is formed on a first surface of the sheet part,
wherein a second surface of the sheet part is adhered to the top surface, the lateral surface and the bottom surface of the spacer so that the antenna forms a U-shape, and
wherein the second surface is located opposite to the first surface.

3. The RFID tag as claimed in claim 2, wherein a shrinkage rate of the sheet part is set to be a designated shrinkage rate between a shrinkage rate of the spacer and a shrinkage rate of the antenna.

4. The RFID tag as claimed in claim 1, further comprising:
a cover made of a third member having flexibility and elasticity, the cover covering the spacer, the antenna and the IC chip.

5. An RFID tag comprising:
a spacer made of a first member having flexibility and elasticity, the spacer having a top surface and a bottom surface;
an antenna made of a conductive material having flexibility and elasticity and disposed on the top surface of the spacer;
an IC chip electrically connected to the antenna; and
an electromagnetic wave reflector made of a conductive material having flexibility and elasticity, the electromagnetic wave reflector being disposed on the bottom surface of the spacer.

6. The RFID tag as claimed in claim 5, further comprising:
a strap having a sheet shape;
wherein the IC chip is formed on a first surface of the strap, and
wherein the strap is adhered to the antenna in a state where the first surface of the strap faces toward the antenna so that the IC chip is electrically connected to the antenna.

7. The RFID tag as claimed in claim 1, wherein the spacer is made of a silicone rubber, a butyl rubber, a nitrile rubber, a nitrile hydride rubber, a fluoride rubber, an epichlorohydrin rubber, an isoprene rubber, a chlorosulfonated polyethylene rubber, a urethane rubber, an elastomer of vinyl chloride series, an elastomer of styrene series, an elastomer of olefin series, an elastomer of ester series, an elastomer of urethane series or an elastomer of amide series.

8. The RFID tag as claimed in claim 1, wherein the antenna is made of a conducting paste including conducting particles and a binder which is mixed with the conducting particles, and wherein the binder is made of a silicone rubber, a butyl rubber, a nitrile rubber, a nitrile hydride rubber, a fluoride rubber, an epichlorohydrin rubber, an isoprene rubber, a chlorosulfonated polyethylene rubber or a urethane rubber.

9. A method for manufacturing an RFID tag comprising:
forming an antenna from a conductive material having flexibility and elasticity on a surface of a sheet part;
mounting an IC chip on the surface of the sheet part so that the IC chip is electrically connected to the antenna; and
adhering the sheet part on a top surface, a lateral surface and a bottom surface of a spacer having flexibility and elasticity, the sheet part being in a state where the IC chip is mounted on the surface of the sheet part.
